(19) United States
(12) Patent Application Publication
(10) Pub. No.: US 2013/0153043 A1
(43) Pub. Date: Jun. 20, 2013

(54) FLOW FORCE-COMPENSATING VALVE ELEMENT WITH LOAD CHECK

(71) Applicant: Wesley Payne, Plainfield, IL (US)

(72) Inventor: Wesley Payne, Plainfield, IL (US)

(73) Assignee: Caterpillar Inc., Peoria, IL (US)

(21) Appl. No.: 13/330,733

(22) Filed: Dec. 20, 2011

(51) Int. Cl. F15B 13/06; F15B 13/02; F15B 11/16

(52) U.S. Cl. 137/14; 60/422; 60/459

(57) ABSTRACT

A fluid system and method of operation provides flow force compensation and load sense functions. Each work circuit includes an actuator, a control valve, and a first valve. A valve element of a control valve includes main metering orifices sized and shaped to provide flow force compensation. A load sense check valve associated with a load pressure signal conduit is downstream of the load check valve. The load pressure signal conduit of each work circuit is in fluid communication with one another, and a greater of the load signal pressure of the work circuits is communicated to the load sense check valve of the other work circuit. The control valve associated the lesser load can permit flow forces to reduce the effective area of the orifice, which increases the pressure difference across the valve to maintain approximately constant flow to the actuator.

### TECHNICAL FIELD

This present disclosure relates generally to a fluid control system and, more particularly, to a pressure-responsive hydraulic system having a load check sensing system and a flow force-compensating system.

### BACKGROUND

When operating two different fluid circuits in parallel with a common pump, the circuit having the lightest load typically will automatically receive the flow of the pump. Likewise, the circuit with the heaviest load will stall or slow to such an extent that the operation of that circuit is severely hampered. Thus, in a hydraulic system with a single pump supplying flow to multiple circuits in parallel, it is desirable to provide a control valve that will meter pump flow to the cylinders independent of the load on the cylinder.

In some conventional fluid control systems, a pressure compensator may be disposed between the meter-in directional control area on a main control spool and an actuator conduit. The compensator regulates the pressure of the flow of oil coming from the meter-in flow control area as needed, such that all fluid circuits will experience the same load pressure and command the same flow as the circuit with the highest load pressure. When all the circuits have equal load pressure, the flow being supplied from the pump to the actuators is proportional to the commanded flow and independent of the load on the cylinder.

For example, U.S. Pat. No. 6,782,697, which is incorporated herein by reference in its entirety, discloses a pressure-responsive hydraulic system with a control valve that may include a pressure-compensating valve. The pressure-compensating valve may include a load check portion and a resolver piston. A signal passageway can be connected to each of the circuits and communicate with a chamber proximate the resolver piston. A load pressure conduit can communicate in a chamber disposed between the load check portion and the resolver piston. The resolver piston may be capable of moving due to pressure within the signal passageway indicative of the highest loaded circuit in order to bias the load check portion closed. To this end, the load check portion can open to allow fluid from the pump to the cylinder when the fluid has a pressure sufficient to overcome the load sense pressure and the force of the biased resolver piston.

Thus, it is desirable to provide a hydraulic system with an arrangement of a load sensing system and a flow force-compensating system that is easier to manufacture and uses less parts than systems with pressure-compensating valves.

### SUMMARY

One or more of the embodiments disclosed herein are directed to overcoming one or more of the problems set forth above. In one example, the disclosure is directed to a fluid system including a source of pressurized fluid and at least two work circuits. An actuator can be in operable communication with the source of pressurized fluid. A control valve can be operable to control fluid communication to and from the actuator. One or both of the control valves can include a valve element having a main metering orifice sized and shaped to provide flow force compensation to the valve element in response to fluid flow through the orifice. A first valve, such as a load check valve or a pressure-compensating valve, can be in fluid communication with the control valve and the actuator. A meter-in passage can direct fluid flow from the meter-in orifice to the load check valve. For example, the first valve can be biased in a sealed position against a control orifice in communication with the meter-in passage. In response to pressure within the meter-in passage being greater than a spring force of the first valve and a pressure in a return passage to be supplied to the respective actuators, the first valve is movable away from the sealed position. A load pressure signal conduit can be in fluid communication between the meter-in passage, the first valve and a tank. The load pressure signal conduit can carry a load sense signal pressure. A load sense check valve can be associated with the load pressure signal conduit downstream of the first valve. The load pressure signal conduit of each of the work circuits can be in fluid communication with one another. A greater of the load signal pressure of the work circuits can be communicated to the load sense check valve of the other work circuit.

In another example, the disclosure is directed to a method of operating a fluid system. The fluid system can have more than one actuator supplied by a single source of pressurized fluid. One step can include directing at least one of: a first valve element of a first directional control valve to move based on a load of a first actuator, wherein the first valve element includes a main metering orifice having a size and shape for flow force compensation; and a second valve element of a second directional control valve to move based on a load of a second actuator, wherein the second valve element includes a main metering orifice sized and shaped for flow force compensation. A load signal pressure associated with each of the first and second actuators can be generated. The load signal pressure can be generated from pressurized fluid supplied via the respective control valves to the respective first and second actuators through a meter-in passage. Each of the meter-in passages can direct fluid flow from the respective first and second directional control valve to a load check valve. A control signal pressure can be generated from the greater of the load signal pressures associated with the respective first and second actuators. The control signal pressure can be directed to a load sense check valve disposed downstream of the load check valve of a circuit of a lesser of the load signal pressure associated with the respective first and second actuators.

In yet another example, the method can include providing a first directional control valve and a second directional control valve. At least one of the control valves has a valve element with central main metering orifice being sized and shaped for flow force compensation. A first load signal pressure can be generated from pressurized fluid supplied via the first directional control valve to a first actuator through a first meter-in passage. The first meter-in passage can direct fluid flow from the first directional control valve and a first valve, such as a load check valve or a pressure-compensating valve. A second load signal pressure can be generated from pressurized fluid supplied via the second directional control valve to a second actuator through a second meter-in passage. The second meter-in passage can direct fluid flow from the second directional control valve and a second valve, such as a load check valve or a pres sure-compensating valve. A control signal pressure can be generated from a greater of the first control signal pressure and the second control signal pressure. The control signal pressure can be directed to a load sense check valve disposed downstream of the respective first and second valves associated with a circuit of a lesser of the first control signal pressure and the second control signal pressure. Flow forces can cause the respective control valve associated with the flow force shaped main metering orifices and the circuit of the lesser of the first and second control signal pressures to reduce the area of the central main metering orifice. Consequently, the pressure differential across the corresponding valve element can be increased to maintain an approximately constant flow to the corresponding actuator.

### BRIEF DESCRIPTION OF THE DRAWINGS

FIG. 1 is a schematic illustration of an example hydraulic system.

FIG. 2 is a diagrammatic illustration of a load check valve and a pressure compensation spool of the system of FIG. 1.

FIG. 3 is a schematic illustration of another example hydraulic system.

### DETAILED DESCRIPTION

Reference will now be made in detail to embodiments of the invention, examples of which are illustrated in the accompanying drawings. Wherever possible, the same reference numbers will be used throughout the drawings to refer to the same or like parts.

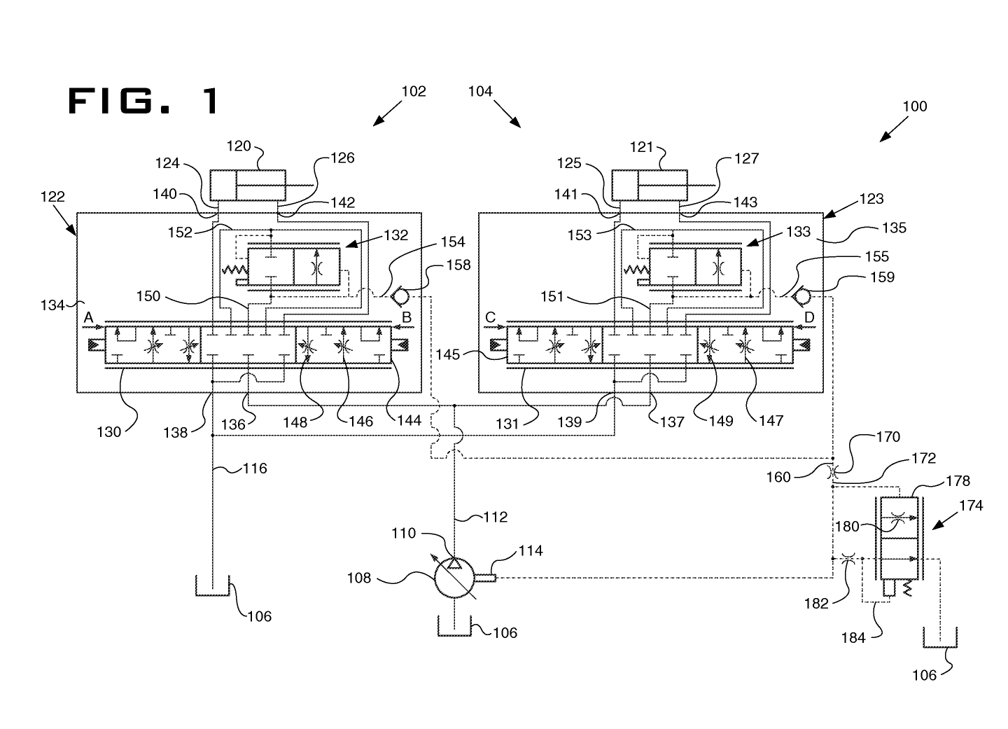

Referring to FIG. 1, an exemplary pressure-responsive hydraulic system 100 may include at least a pair of work circuits 102, 104, a tank 106, and a load-sensing, variable-displacement pump 108 connected to the tank 106. The number of work circuits within the system can be more than two, such as three, four, five, etc., though the description will focus on the application of two work circuits. The pump 106 may have a discharge port 110 connected to the work circuits 102, 104 in a parallel flow relationship through a common supply conduit 112. The pump may include a pressure-responsive displacement controller 114 for controlling fluid flow through the discharge port 110 and supply conduit 112. An exhaust conduit 116 may be connected to the tank 106 and both work circuits 102, 104.

The work circuit 102 may include an actuator 120, for example, a double-acting hydraulic cylinder, and a control valve 122 connected thereto through a pair of actuator conduits 124, 126. The work circuit 104 similarly includes an actuator 121, for example, a double acting hydraulic cylinder, and a control valve 123 connected thereto through a pair of actuator conduits 125, 127. Both control valves 122, 123 may be connected to the supply conduit 112 and to the exhaust conduit 116.

The control valve 122 may include a directional control valve 130 and a load check valve 132, both of which may be housed in a common body 134. The body 134 may have an inlet port 136 connected to the supply conduit 112, an exhaust port 138 connected to the exhaust conduit 116, and a pair of actuator ports 140, 142 connected to the actuator conduits 124, 126, respectively.

The directional control valve 130 may include a valve member 144 having an infinitely variable meter-in orifice 146 and an infinitely variable meter-out orifice 148. The valve member 144 is movable from the neutral position shown in FIG. 1 to an infinite number of variable operating positions in directions A and B, with the size of the metering orifices 146, 148 being controlled by the extent to which the valve member 144 is moved from the neutral position. The valve member 144, such as a spool, may be configured for flow force compensation. To this end, each of the meter-in orifices 146, meter-out orifices 148, or both is sized and shaped to permit flow forces, or axial thrust, on the valve member 144, as will be explained.

The control valve 122 may include a meter-in transfer passage 150 providing fluid communication between the directional control valve 130 and the load check valve 132. A return passage 152 may provide fluid communication from the load check valve 132 back to the directional control valve 130 for routing to a working chamber of the actuator 120. A load pressure signal conduit 154 may be associated with the transfer passage 150. The control valve 122 may include a check valve 158 associated with the load pressure signal conduit 154.

Similarly, the control valve 123 may include a directional control valve 131 and a load check valve 133, both of which may be housed in a common body 135. The body 135 may have an inlet port 137 connected to the supply conduit 112, an exhaust port 139 connected to the exhaust conduit 116, and a pair of actuator ports 141, 143 connected to the actuator conduits 125, 127, respectively.

The directional control valve 131 may include a valve member 145 having an infinitely variable meter-in orifice 147 and an infinitely variable meter-out orifice 149. The valve member 145 is movable from the neutral position shown in FIG. 1 to an infinite number of variable operating positions in directions C and D, with the size of the metering orifices 147, 149 being controlled by the extent to which the valve member 145 is moved from the neutral position. The valve member 145, such as a spool, may be configured for flow force compensation. To this end, each of the meter-in orifices 147, the meter-out orifices 149, or both is sized and shaped to induce flow forces, or axial thrust, on the valve member 145, as will be explained.

The control valve 123 may include a meter-in transfer passage 151 providing fluid communication between the directional control valve 131 and the load check valve 133. A return passage 153 may provide fluid communication from the load check valve 133 back to the directional control valve 131 for routing to a working chamber of the actuator 121. A load pressure signal conduit 155 may be associated with the transfer passage 151. The control valve 123 may include a check valve 159 associated with the load pressure signal conduit 155.

The load pressure signal conduits 154, 155 from the work circuits 102, 104 may be in fluid communication with one another upstream of a signal orifice 170. A signal conduit 172 is disposed downstream of the signal orifice 170. The signal conduit 172 may be in fluid communication with the pressure-responsive displacement controller 114. The hydraulic system 100 may include a sink valve 174 associated with the signal conduit 172. The sink valve 174 may include a valve member 178 having an infinitely variable metering orifice 180. Another orifice 182 may be associated with a sink supply conduit 184.

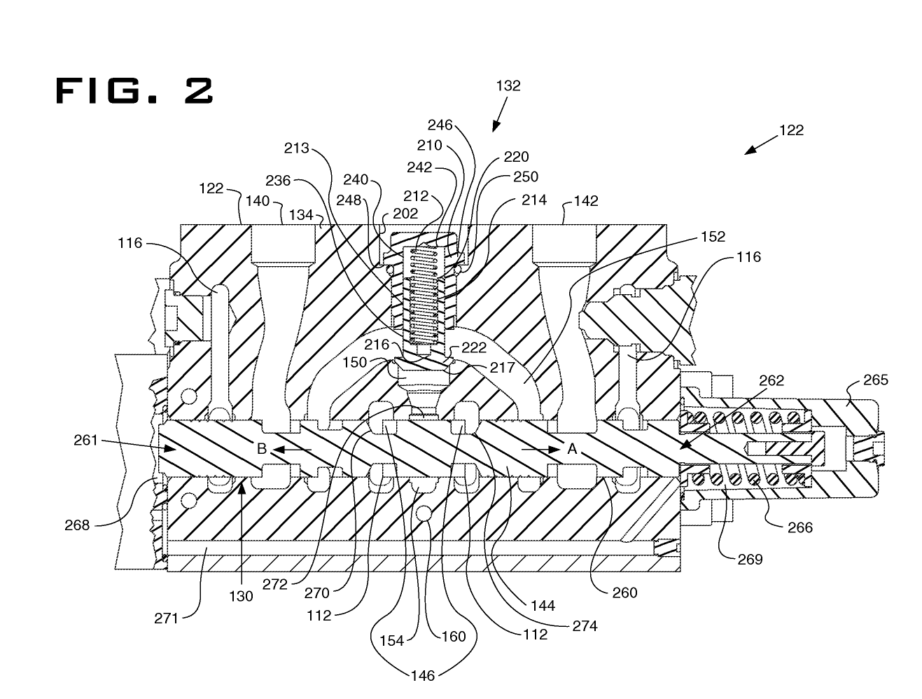

Referring now to FIG. 2, the load check valve 132 may be disposed in a bore 202 in the body 134 of the control valve 122. The bore 202 may be open or closed at one end by a plug, which may be mounted in the bore 202 by a screw thread or any other conventional connection. In FIG. 2, the fluid passage 160 leading to the check valve 158 and its proximity to the metering transfer passage 150 is also depicted. The check valves 158, 159 and the signal orifice 170 can be disposed in a plane that is different than the one shown in FIG. 2.

The load check valve 132 may include a spool housing 210, a load check spring 212 disposed within the spool housing 210, and a spool 213 biased by the spring 212, which is also at least partially contained within the spool housing 210. In one example, the load check valve is a poppet valve. The spool 213 can include a central, longitudinal throughbore 214 closed at its first end 216. The second end 220 of the throughbore 214 may be open, e.g., to permit the passage of the spring 212. The end 222 of the spool 213 opposite the load check spring 212 can sealably engage the control orifice 217 of the meter-in transfer passage 150. The spool end 222 may be wider than the remainder of the spool 213. In one example, the spool end 222 is tapered to provide an increased sealing surface and to account for variations in tolerances.

The spool housing 210 can include a longitudinal opening 240 sized to receive the cross-sectional area of the spool 213. The opening 240 can be closed at a first end 242. The spring 212 can be internally located within the throughbore 214 of the spool 213 and the opening 240 of the spool housing 210. The spring 212 can be longitudinally extended between inner surfaces of the respective first end 242 of the spool housing 210 and the first end 216 of the spool 213. The spool housing 210 can be fixedly attached to the body 134. In one example, the exterior of the spool housing 210 may include a radial flange 246 to engage an internal shoulder 248 of the body. A sealing member 250 such as an O-ring can be placed between the spool housing 210 and the body 134 to prevent leakage within the bore 202 in the body 134.

The load check valve 132 is movable between an open configuration and a closed configuration by movement of the spool 213 between a first position and a second position, respectively. In the closed position, the spool 213 is in its first position such that the spool end 222 of the spool 213 sealably engages the control orifice 217 of the meter-in transfer passage 150. The spring 212 can provide a biasing force to bias the spool 213 in its first position. In the open position, the spool 213 is in its second position such that the spool end 222 of the spool 213 removed from engagement with the control orifice 217 of the meter-in transfer passage 150. Movement of the spool 213 to its second position occurs when pressure within the control orifice 217 region is greater than the biasing force of the spring 212 and the force provided by the pressurized return passage 152. In other words, there is a build up of cylinder pressure at load check valve 132 before the load check valve 132 is opened to avoid any undesirable cylinder movement, generally movement in a direction opposite to the desired direction. Such degree of pressure can urge the spool end 222 of the spool 213 away from sealable engagement with the control orifice 217 to permit fluid flow to the return passage 152. The spool 213 may also include an annular groove 236 in a central portion thereof. The annular groove 236 may be adjacent to the end 222. The annular groove 236 may be in fluid communication with the return passage 152.

FIG. 2 also depicts the directional control valve 130 contained within the housing 134 of the control valve 122 and its relationship to the load check valve 132. The directional control valve 130 is shown with the valve element 144 slidably disposed within a valve bore 260 formed within the housing at select positions. Depending on the position of the valve element, the fluid flow is controlled between the supply conduit 112, the actuator 120 via the actuator conduits 124, 126, the tank 106, and the load check valve 132 via the meter-in transfer passage 150 and the return passage 152. A first end 261 of the valve element 144 can be associated with one or more solenoid assemblies (not shown) to allow proportional control of the valve element 144 to any desired position. A second end 262 of the valve element 144 can be associated with a spring housing assembly 265. The spring housing assembly 265 houses a centering spring 266 coupled to the second end 262.

The centering spring 266 can include one or more biasing members such as springs to a biasing force to maintain the valve element 144 in its neutral position (FIG. 2) when no control signal has been received by the solenoid assembly. In response to the solenoid assembly receiving a control signal, such as a variable current signal representative of a displacement command as a function of flow rate, from a controller initiated by the operator, e.g., through a lever command, the solenoid assembly can electromagnetically move the valve element 144 from its neutral position in the direction of directions A or B, as can be appreciated by those skilled in the art. In one example, actuation of a solenoid assembly can permits pilot pressure to enter one of the end chambers 268, 269 to build a force greater than the bias of the centering spring 266. In one example, a pair of solenoid assemblies is located in closer proximity to the first end 261. During energization of the solenoid assembly, pilot pressure is communicated to the end chamber 268 or the opposite end chamber 269 disposed within the spring housing 265 via a fluid conduit 271 formed in the body. To this end, the valve element 144 is movable against the bias of the spring 266 to any position between three distinct operation positions by way of the solenoid assembly: its first, neutral position, a second position in direction A, and a third position in direction B.

In one example, shown in FIG. 2, the valve element 144 may be a spool having at least one land 270 separating a first annular recess 272 from a second annular recess 274 that form the meter-in orifices 146. The meter-in orifices 146 are shown sized and shaped to permit flow forces on the valve member 144 in order to position the valve element in a manner to provide a constant fluid flow or substantially constant fluid flow for the load demands of the actuator.

It is contemplated that fluid flowing through the meter-in orifices of the control valve 132 may flow at a rate proportional to an effective valve area Aᵥₐₗᵥₑ of the corresponding meter-in orifices and proportional to the square root of the pressure gradient across the valve ΔP, based on a commonly-known orifice equation, Equation 1, below:

$$Q = {A}_{valve} {C}_{d} \sqrt{\frac{2 Δ P}{ρ}} \qquad Equation 1$$

wherein:
   Q is the flow rate of fluid into the actuator 120 and through the control valve 130;
   Aᵥₐₗᵥₑ is the effective area of the control valve 130;
   C_{d} is a discharge coefficient;
   ρ is a density of the fluid passing through the control valve 130; and
   ΔP is a pressure gradient across the control valve 130.

The discharge coefficient C_{d} may be used to approximate viscosity and turbulence effects of fluid flow and may be within the range of about 0.5-0.9. The discharge coefficient C_{d} and the fluid density ρ can be substantially constant. Thus, for a desired constant flow Q, it is contemplated that the effective area Aᵥₐₗᵥₑ can be reduced or increased with movement of the control valve 130 inversely proportional to increase or reduction in the variable ΔP. To this end, having determined the flow rate of fluid that should enter the actuator 120 to cause the pump to respond appropriately to the varying ΔP caused by the flow forces can provide a sort of quasi pressure compensation to the system.

As fluid moves through the directional control valve 130, inertia, turbulence, and/or viscosity of the fluid itself may exert forces on the valve element 144 in the opposite direction of desired direction for movement. The flow forces acting on the valve element 144 may be estimated using Equation 2 provided below:

f_{f}=2·C_{d}·Aᵥₐₗᵥₑ·ΔP·cos(φ) Equation 2
wherein:
   f_{f} are the flow forces;
   C_{d} is the discharge coefficient;
   Aᵥₐₗᵥₑ is the effective area of the control valve 130;
      ΔP is the pressure gradient across the control valve 130; and
   φ is an angle of fluid exodus from Aᵥₐₗᵥₑ.

To this end, the flow forces tend to reduce the effective area Aᵥₐₗᵥₑ, which results in an increased ΔP across the valve to keep flow approximately constant and thus provide pressure compensation to the system. Although the exit angle φ may vary, in one example, φ may be assumed to be constant based on laboratory testing, and used to approximate the trajectory of flow forces exiting Aᵥₐₗᵥₑ. Since ΔP, Aᵥₐₗᵥₑ, φ, and C_{d} may be known values, f_{f} may be estimated and then utilized during movement of the control valve 130. For example, the effective area Aᵥₐₗᵥₑ can be approximated based on the valve cutter geometry of the meter-in orifices 146 (that is shape, depth, and angle) to provide a net closing force as a function of the fluid jet angle and fluid jet velocity. The force provided by the spring 266 is sized appropriately to overcome the flow forces.

As with conventional pressure compensators which are configured to provide a constant pressure differential across the directional control valve regardless of the load demands of the actuators, flow force compensating valve element configurations described herein permit the effective area Aᵥₐₗᵥₑ of the meter-in orifices to be reduced proportional to the pressure difference ΔP increase to provide a constant fluid flow or substantially constant fluid flow with the load demands of the actuator.

### INDUSTRIAL APPLICABILITY

In the use of the embodiments described herein, the operator can actuate one or both of the hydraulic actuators 120, 121 by manipulating the appropriate directional control valve 130, 131. For example, if the operator wishes to extend the hydraulic actuator 120, the valve member 144 of the directional control valve 130 is moved rightward to the second position in the direction of arrow A.

With this exemplary embodiment, the following events sequentially occur when the valve member 144 is moved to the second position in direction A. Fluid communication is established between the inlet port 136 and the meter-in transfer passage 150 and between the rod end actuator conduit 126 and the exhaust port 138. Also, the return passage 152 from the load check valve 132 is placed in fluid communication with the head end actuator conduit 124.

If the operator wishes to retract the hydraulic actuator 120, the valve member 144 of the directional control valve 130 is moved leftward to the third position in the direction of arrow B. In this exemplary embodiment, when the valve member is moved to the third position in direction B, fluid communication is established between the inlet port 136 and the meter-in transfer passage 150 and between the head end actuator conduit 124 and the exhaust port 138. Also, the return passage 152 from the load check valve 132 is placed in fluid communication with the rod end actuator conduit 126.

The hydraulic actuator 120 may be operated contemporaneously with or at a different time that the hydraulic actuator 121. If the operator wishes to extend the hydraulic actuator 121, the valve member 145 of the directional control valve 131 is moved rightward in the direction of arrow C. When the valve member 145 is moved in direction C, fluid communication is established between the inlet port 137 and the meter-in transfer passage 151 and between the rod end actuator conduit 127 and the exhaust port 139. Also, the return passage 153 from the load check valve 133 is placed in fluid communication with the head end actuator conduit 125.

If the operator wishes to retract the hydraulic actuator 121, the valve member 145 of the directional control valve 131 is moved leftward in the direction of arrow D. In this exemplary embodiment, when the valve member is moved in direction D, fluid communication is established between the inlet port 137 and the meter-in transfer passage 151 and between the head end actuator conduit 125 and the exhaust port 137. Also, the return passage 153 from the load check valve 133 is placed in fluid communication with the rod end actuator conduit 127.

When the hydraulic actuators 120, 121 are operated simultaneously, the respective load pressures in the signal conduits 154, 155 are monitored. As a result, whichever load pressure signal conduit 154, 155 carries a greater signal pressure will unseat the respective check valve 158, 159 and communicate such load pressure to the fluid passage 160. The check valve associated with the conduit carrying the lesser signal pressure will remain closed, and can be aided to remain closed with the pressure communicated from the conduit carrying the greater signal pressure. Since the load pressure signal conduits 154, 155 are in fluid communication with the respective meter-in transfer passages 150, 151, the signal pressure communicated to the signal conduits 154, 155 can be proportionate to the load that each hydraulic actuator 120, 121 is experiencing. Consequently, the signal pressure that unseats the check valve can be associated with whichever hydraulic actuator 120, 121 is experiencing the larger load.

For example, if hydraulic actuator 120 is being operated to dump a load, for example, on a bucket loader, and the hydraulic actuator 121 is being operated to lift the load, for example, on the bucket loader, hydraulic actuator 121 may be experiencing a significantly larger load. Thus, the meter-in transfer passage 151 may contain fluid at a greater pressure than the fluid in the meter-in transfer passage 150. As a result, the signal pressure of the load pressure signal conduit 155 can unseat the check valve 159, while the check valve 158 can remain closed.

The pressurized fluid from the work circuit 104 with the highest load can flow through the check valve 159 to the fluid passage 160 and subsequently to the signal orifice 170 where the pressure drops across the signal orifice 170. The pressure drop across the signal orifice 170 allows the check valve 159 in the work circuit 104 with the highest load to open. The signal orifice 170 may be sized such that a percentage of the pump margin, for example, about 25% of the pump margin, will drop across the signal orifice 170 when the regulated drain flow passes through. The sink valve 174 can provide the regulated drain flow and can unload the signal when all of the directional control valves 132, 133 are in neutral.

With the flow force compensating valve element, a command for fluid flow rate is given based on the position of the lever. A control signal, representative of the desired flow rate, is sent to the solenoid to move the valve element. Movement of the valve element to a desired position within the directional control valve results in a desired area of the meter-in orifice to arrive at the desired fluid flow rate. A change in load demands of the actuator results in movement of the valve element to change the area of the meter-in orifice. For example, as the load demands change for the actuator, the valve element is moved to a position to change the area of the meter-in orifice regardless of the pressure differential across the valve element to maintain a constant fluid flow based on the position of the lever command. The control valve associated with the conduit carrying the lesser load will permit flow forces to reduce the effective area of the meter-in orifices, which increases the pressure difference across the valve. As a result, the fluid flow across the valve can be maintained approximately constant and thus provide a self-adjusting pressure compensation to the system. To this end, each of the hydraulic cylinders 120, 121 can operate as if they are experiencing the same load. Thus, the flow to each of the hydraulic cylinders can be proportional to the load as modified by the signal pressure, rather than the load pressure of the respective actuators 120, 121.

The signal pressure in the signal conduit 172 can be also in fluid communication with sink valve 174 and the pressure-responsive displacement controller 114. Sink valve 174 can regulate flow from the signal conduit 172 to the tank 106 and allows venting of fluid when the directional control valves 130, 131 are in neutral. If one of the work circuits 102, 104 bottoms out, a relief valve (not shown) can allow other work circuits to continue operating, such as described in the previously incorporated U.S. Pat. No. 6,782,697. The relief valve also can limit the signal pressure to prevent the pump 108 from exceeding capacity.

In view of the above, it is readily apparent that the system described herein can provide an improved and simplified control valve in which the valve element and its orifices are capable of providing meter-in pressure compensating in the system through flow force compensation. The system does not require the use of a separate pressure compensating valve element, such as the use of a cylinder pressure resolver, a signal duplicating valve, or a directional spool to vent the signal to tank when the spool is in neutral. The system also includes a load check function in fluid communication with the main spool bridge. The provision of a load sense signal upstream, rather than downstream, of the load check valve avoids the possibility of leakage of fluid to the cylinders due to inadvertent displacement of the directional control valve. The leakage can cause the cylinder actuator in an unintended manner. The load check valve arrangement in relation to the flow force compensation valve provides a simplified system having reduced manufacturing costs in providing highly precision bores and ports of conventional systems, with suitable pressure compensating performance.

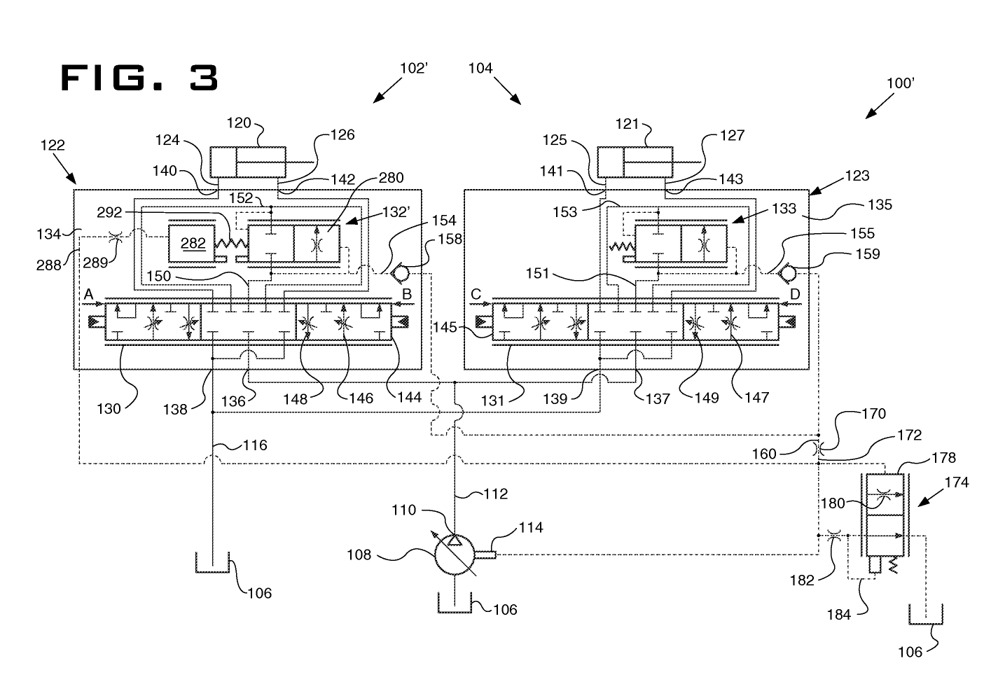

Although focus has been directed to replacement of a separate pressure compensator circuit, such as, e.g., the one described in the previously incorporated U.S. Pat. No. 6,782,697, FIG. 3 illustrates at least one work circuit 102′ may include the seprarate pressure compensator circuit, whereas one work circuit 104 can include the flow force compensating valve element with load check arrangement shown in FIGS. 1-2. However, it can be appreciated that the pressure-compensation valve arrangement is exemplary only and that other pressure-compensation valve arrangements known in the art can be substituted in its place.

In FIG. 3, the system 100′ can include all of the components of the system 100, except as explained below. For instance, the circuit 102′ includes a pressure-compensating valve 132′. The pressure-compensating valve 132′ can include a load check portion 280 and a resolver piston 282. A first chamber (not shown) may be defined between the resolver piston 282 and a plug (not shown), and a second chamber (not shown) may be defined between the load check portion 280 and the resolver piston 282. The first chamber may be in fluid communication with a control pressure conduit 288 and the second chamber may be in fluid communication with the load pressure signal conduit 154. The control pressure conduit 288 may be in fluid communication with the signal conduit 172 and the pressure-responsive displacement controller 114. An orifice 289 can be associated with the control pressure conduit 288. In one example, the resolver piston 282 may be urged away from the plug by a balancing spring, such as described in the previously incorporated U.S. Pat. No. 6,782,697. A load check spring 292 may be disposed between the resolver piston 282 and the load check portion 280.

The signal pressure in the signal conduit 172 can be in fluid communication with the first chamber above the resolver piston 282 of the pressure-compensating valve 132′ via the control pressure conduit 288. The resolver piston 282 can be slidable within a bore of the valve body. Thus, the signal pressure in the signal conduit 172 can urge the resolver piston 282 toward the load check portion 280 of the pressure-compensating valves 132′.

It will be apparent to those skilled in the art that various modifications and variations can be made in the disclosed fluid control system without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims and their equivalents.

1-20. (canceled)

21. A method of operating a hydraulic system having more than one actuator supplied by a single source of pressurized fluid, the method comprising:
directing at least one of:
a first valve element of a first directional control valve to move based on a load of a first actuator, wherein the first valve element includes a main metering orifice having a size and shape for flow force compensation; and
a second valve element of a second directional control valve to move based on a load of a second actuator, wherein the second valve element includes a main metering orifice sized and shaped for flow force compensation;
generating a load signal pressure associated with each of the first and second actuators, the load signal pressure being generated from pressurized fluid supplied via the respective control valves to the respective first and second actuators through a meter-in passage, wherein each of the meter-in passages directs fluid flow from the respective first and second directional control valve to a load check valve;
generating a control signal pressure from the greater of the load signal pressures associated with the respective first and second actuators; and
directing the control signal pressure to a load sense check valve disposed downstream of the load check valve of a circuit of a lesser of the load signal pressure associated with the respective first and second actuators.

22. The method of claim 21, further comprising determining a desired flow rate for each of the first and second actuators based on the load of the respective actuator.

23. The method of claim 22, wherein each of the first and second valve elements are configured to move based on flow forces to reduce the area of the main metering orifice.

24. The method of claim 23, wherein the reduced area of each of the first and second valve elements permits an, increase in pressure differential across the valve element in order to maintain an approximately constant flow to the actuators.

25. The method of claim 23, wherein each of the first and second valve elements is a spool.

26. The method of claim 25, wherein the main metering orifice is disposed along the center of the spool.

27. The method of claim 21, wherein the directing step further comprises providing pilot pressure to an end chamber to direct the respective first and second valve elements to move.

28. The method of claim 21, wherein the load check valve is a poppet valve that is movable between an open position and a closed position.

29. The method of claim 21, wherein in the closed position the load check valve is biased in a sealed position against a control orifice in communication with the meter-in passage, and in the open position the load check valve is moved away from the sealed position with the control orifice in response to a pressure within the meter-in passage being greater than a spring force of the load check valve and a pressure in a return passage to be supplied to the respective actuators.

30. The method of claim 21, further comprising regulating flow of the control signal pressure to a fluid reservoir.

31. A method of operating a hydraulic system having more than one actuator supplied by a single source of pressurized fluid, the method comprising:
providing a first directional control valve and a second directional control valve, at least one control valve having a central main metering orifice being sized and shaped for flow force compensation;
generating a first load signal pressure from pressurized fluid supplied via the first directional control valve to a first actuator through a first meter-in passage, wherein the first meter-in passage is directing fluid flow from the first directional control valve and a first valve;
generating a second load signal pressure from pressurized fluid supplied via the second directional control valve to a second actuator through a second meter-in passage, wherein the second meter-in passage is directing fluid flow from the second directional control valve and a second valve;
generating a control signal pressure from a greater of the first control signal pressure and the second control signal pressure; and
directing the control signal pressure to a load sense check valve disposed downstream of the respective first and second valves associated with a circuit of a lesser of the first control signal pressure and the second control signal pressure, wherein flow forces cause the respective directional control valve when with the circuit is the lesser of the first and second control signal pressures to reduce the area of the central main metering orifice, thereby increasing the pressure differential across the corresponding valve element to maintain an approximately constant flow to the corresponding actuator.

32. The method of claim 31, further comprising regulating flow of the control signal pressure to a fluid reservoir.

33. The method of claim 31, wherein one of the first and second valves is a load check valve and the other of the first and second valves is a pressure-compensating valve.

34. The method of claim 33, wherein the load check-valve is a poppet valve that is movable between an open position and a closed position.

35. A fluid system, comprising:
a source of pressurized fluid;
at least two work circuits, each circuit including:
an actuator in operable communication with the source of pressurized fluid;
a control valve operable to control fluid communication to and from the actuator, the control valve including a valve element having a main metering orifice;
a first valve in fluid communication with the control valve and the actuator;
a meter-in passage directing fluid flow from the meter-in orifice to the first valve, wherein the first valve is biased in a sealed position against a control orifice in communication with the meter-in passage, and in response to pressure within the meter-in passage being greater than a spring force of the first valve and a pressure in a return passage to be supplied to the respective actuators, the first valve is movable away from the sealed position,
wherein the main metering orifice of the valve element of at least one of the control valves is sized and shaped to provide flow force compensation to the valve element in response to fluid flow through said orifice;
a load pressure signal conduit in fluid communication between the meter-in passage, the first valve and a tank, the load pressure signal conduit carrying a load sense signal pressure; and
a load sense check valve associated with the load pressure signal conduit downstream of the first valve, wherein the load pressure signal conduit of each of the work circuits is in fluid communication with one another, a greater of the load signal pressure of the work circuits being communicated to the load sense check valve of the other work circuit.

36. The system of claim 35, wherein the respective valve element is configured to move based on flow forces to reduce the area of the main metering orifice, wherein in response to reducing the area, the pressure differential across the valve element is increased in order to maintain an approximately constant flow to the corresponding actuator.

37. The system of claim 36, wherein the valve elements is a spool.

38. The system of claim 37, wherein the main metering orifice is disposed along the center of the spool.

39. The system of claim 35, wherein the first valve of the control valve associated with the valve element having the main metering orifices sized and shaped to provide flow force compensation is a poppet valve that is movable between an open position and a closed position.

40. The system of claim 15, wherein the first valve of the control valve not associated with the valve element having the main metering orifices sized and shaped to provide flow force compensation is a pressure-compensating valve.
